(19) United States
(12) Patent Application Publication
(10) Pub. No.: US 2025/0313388 A1
(43) Pub. Date: Oct. 9, 2025

(54) FOOD CONTAINER WITH VISUAL INDICATION AND RELATED METHODS

(71) Applicant: GLOBAL CAVIAR INC., Brooklyn, NY (US)

(72) Inventor: ARIEL GORELIK, BROOKLYN, NY (US)

(21) Appl. No.: 19/171,604

(22) Filed: Apr. 7, 2025

Related U.S. Application Data
(60) Provisional application No. 63/631,032, filed on Apr. 8, 2024.

(51) Int. Cl. B65D 51/24; B65D 25/14; B65D 85/00

(52) U.S. Cl. CPC B65D 51/248; B65D 25/14; B65D 85/70

(57) ABSTRACT

A food container includes a housing defining a food receiving recess and having a closed first end and an open second end opposite the closed first end, and a lid to be received by the open second end of the housing and having opposing first and second major surfaces. The first major surface faces the food receiving recess, and the second major surface defines a recess. The food container also includes an electronic device to be received by the recess and having a device housing, a battery carried within the device housing, a visual indicator carried by the device housing and coupled to the battery, and a processor carried by the device housing and coupled to the battery and the visual indicator. The processor is configured to cause the visual indicator to generate a visual indication.

### RELATED APPLICATION

This application is based upon prior filed copending Application No. 63/631,032 filed Apr. 8, 2024, the entire subject matter of which is incorporated herein by reference in its entirety.

### TECHNICAL FIELD

The present disclosure relates to the field of food containers, and, more particularly, to a food container with light features and related methods.

### BACKGROUND

Food packaging is a robust international industry. Indeed, the industry generated about $400 billion in revenue in 2024. Depending on the product and application, the features for food packaging can vary greatly. For some applications, protection during transportation and direct customer appeal are important. In some luxury products, aesthetic appeal of the packaging may be important.

### SUMMARY

Generally, a food container (e.g., caviar container) comprises a housing defining a food receiving recess therein and having a closed first end and an open second end opposite the closed first end, and a lid to be received by the open second end of the housing and having opposing first and second major surfaces. The first major surface faces the food receiving recess, and the second major surface defines a recess. The food container also includes an electronic device to be received by the recess and comprising a device housing, a battery carried within the device housing, a visual indicator carried by the device housing and coupled to the battery, and a processor carried by the device housing and coupled to the battery and the visual indicator. The processor is configured to cause the visual indicator to generate a visual indication.

In some embodiments, the electronic device may comprise a sensor carried by the device housing and coupled to the processor, and the processor may be configured to activate the visual indicator based upon the sensor. The sensor may comprise an ambient light sensor, and the processor may be configured to activate the visual indicator when the ambient light sensor detects an ambient light value below a threshold value. Also, the sensor may comprise a proximity sensor, and the processor may be configured to activate the visual indicator when the proximity sensor detects a moving object within a threshold distance. The recess may define a canted annular lid wall, and the device housing may define a canted annular device wall to abut the canted annular lid wall.

Further, the visual indicator may comprise at least one light emitting diode (LED) carried by an external surface of the device housing. The electronic device may comprise an overlayer on the visual indicator, the overlayer comprising visual indicia. The uppermost portions of the lid may be flush and aligned with uppermost portions of the device housing. For example, the recess may comprise a circle-shaped recess, and the device housing may be disc-shaped and received by the circle-shaped recess. The lid and the housing may each comprise a metallic material, the device housing may comprise a plastic material, and the housing may comprise inner surfaces defining the food receiving recess, and a coating layer on the inner surfaces.

Another aspect is directed to a method for making a food container. The method comprises forming a housing defining a food receiving recess therein and having a closed first end and an open second end opposite the closed first end, and forming a lid to be received by the open second end of the housing and having opposing first and second major surfaces, the first major surface to face the food receiving recess, the second major surface defining a recess. The method also includes positioning an electronic device to be received by the recess. The electronic device includes a device housing, a battery carried within the device housing, a visual indicator carried by the device housing and coupled to the battery, and a processor carried by the device housing and coupled to the battery and the visual indicator, the processor configured to cause the visual indicator to generate a visual indication.

### BRIEF DESCRIPTION OF THE DRAWINGS

FIG. 1 is a perspective view of a food container, according to the present disclosure.

FIG. 2 is a side view of a lid from the food container of FIG. 1.

FIG. 3 is a perspective view of an electronic device from the food container of FIG. 1.

FIG. 4 is a side view of the electronic device from the food container of FIG. 1.

FIG. 5 is a side view of the food container of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout.

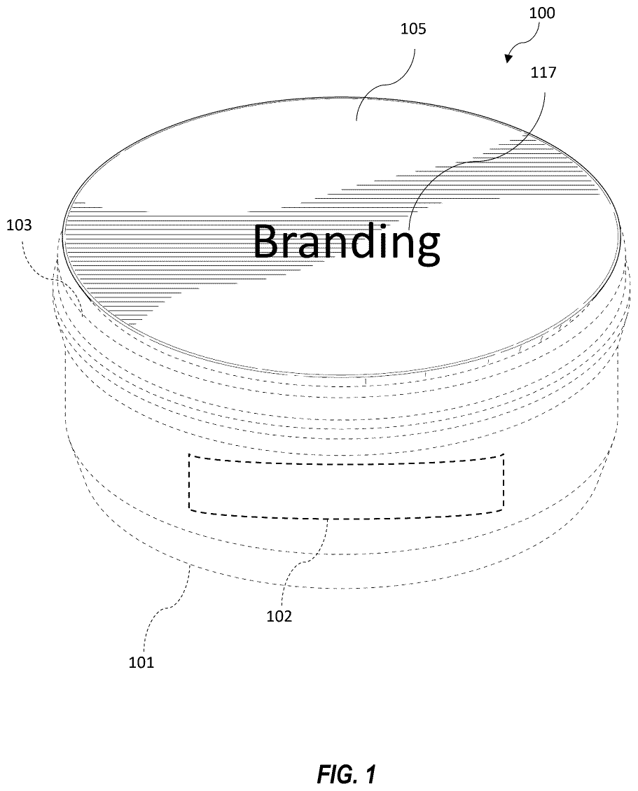

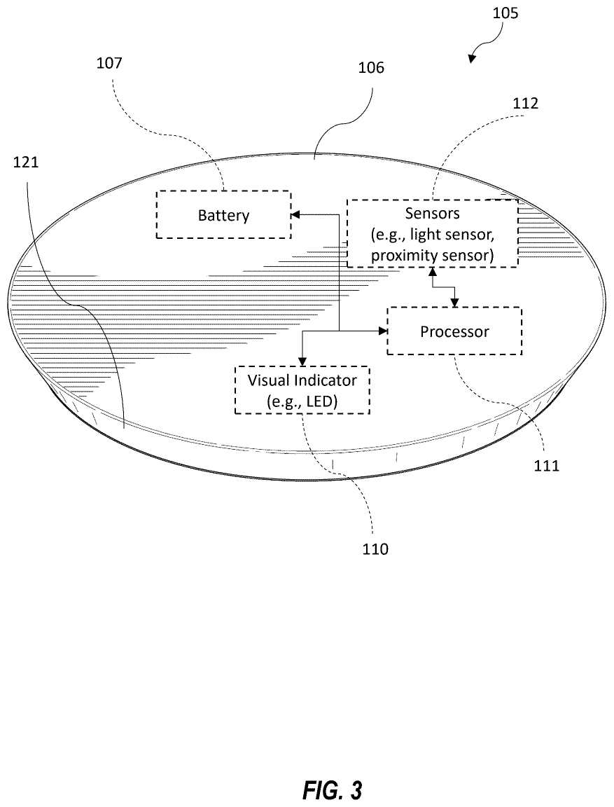

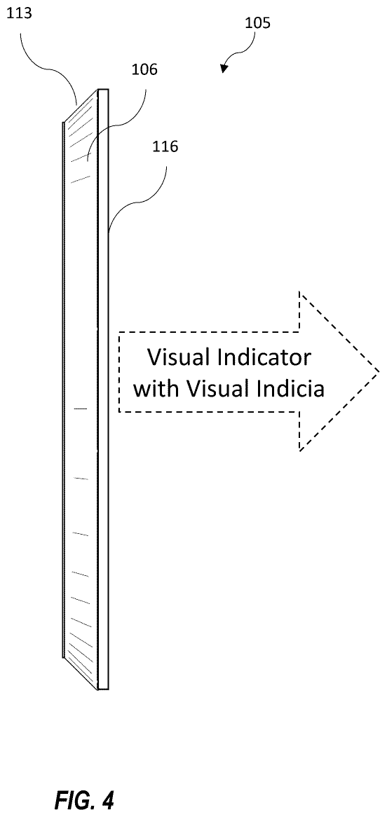

Referring to FIGS. 1-5, a food container 100 according to the present disclosure is now described. The food container 100 illustratively comprises a housing 101 defining a food receiving recess 102 therein. As will be appreciated, the food receiving recess 102 may receive many types of food, for example, caviar.

The housing 101 comprises a closed first end and an open second end opposite the closed first end. Although the illustrated embodiment has a cylinder-shaped housing 101 and cylinder-shaped food receiving recess 102, in other embodiments, the housing 101 may have other shapes, such as a shape with tapering sides, a rectangle-box shape, or a pyramid-shape, for example. The housing 101 may comprise a rigid material suitable for food storage, such as plastic or aluminum.

The food container 100 illustratively includes a lid 103 to be received by the open second end of the housing 101 and having a first major surface 104a and a second major surface 104b opposing the first major surface. The first major surface 104a is to face the food receiving recess 102, and the second major surface 104b defines a circle-shaped recess 108. The lid 103 may comprise a rigid material suitable for food storage, such as plastic or aluminum. The lid 103 may be coupled to the open second end of the housing 101 via a mechanical interface. The mechanical interface may comprise a threaded interface, an interlocking interface, or a pressure fit interface.

The food container 100 also includes a light device 105 to be received by the circle-shaped recess. The light device 105 comprises a disc-shaped housing 106, a battery 107 carried within the disc-shaped housing, and a visual indicator 110 carried by the disc-shaped housing. In the illustrated embodiment, the disc-shaped housing 106 comprises a circle-shaped disc shape, but in other embodiments, the disc-shaped housing 106 may have other shapes that match the varying shape of the housing 101.

The visual indicator 110 is coupled to the battery 107, and configured to generate a visual indication. For example, the visual indicator 110 may comprise one or more LEDs carried by the external surface of the disc-shaped housing 106. As will be appreciated, the visual indicator 110 may provide enhanced aesthetics for the food container 100. The light device 105 illustratively includes a processor 111 and one or more sensors 112 to control activation of the visual indicator 110. In one exemplary embodiment, the one or more sensors comprise a proximity sensor, and the processor is configured to activate the visual indicator 110 when a user's hand is detected. In another exemplary embodiment, the one or more sensors comprise an ambient light sensor, and the processor is configured to activate the visual indicator 110 when ambient light is below a threshold.

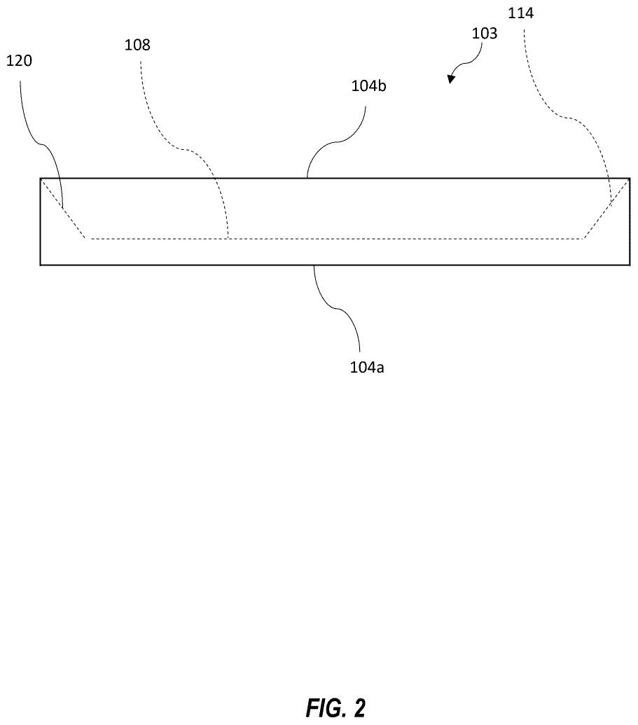

As perhaps best seen in FIGS. 2 & 4, the light device 105 and the circle-shaped recess 108 have matching canted annular walls 113, 114. The matching canted annular walls 113, 114 may provide for a tight and secure fit of the light device 105 and the lid 103.

Another aspect is directed to a method for making a food container 100. The method comprises forming a housing 101 defining a food receiving recess 102 therein and having a closed first end and an open second end opposite the closed first end. The method further includes forming a lid 103 to be received by the open second end of the housing 101 and having opposing first and second major surfaces 104a-104b. The first major surface 104a is to face the food receiving recess 102, and the second major surface 104b defines a circle-shaped recess. The method also includes positioning a light device 105 to be received by the circle-shaped recess. The light device 105 comprises a disc-shaped housing 106, a battery 107 carried within the disc-shaped housing, and a visual indicator 110 carried by the disc-shaped housing, coupled to the battery, and configured to generate a visual indication.

Referring again to FIGS. 1-5, a caviar container 100 according to the present disclosure is now described. Of course, it should be appreciated that the caviar container 100 may be used to store other food products or non-food products in other applications. The caviar container 100 includes a housing 101 comprising inner surfaces defining a food receiving recess 102, and a coating layer 115 on the inner surfaces. As will be appreciated, the coating layer 115 may provide protection from adulteration for the caviar in the food receiving recess 102. The housing 101 also includes a closed first end (i.e., bottom end) and an open second end opposite the closed first end.

The caviar container 100 also comprises a lid 103 to be received by the open second end of the housing 101 and having opposing first and second major surfaces 104a-104b. Each of the opposing first and second major surfaces 104a-104b is substantially flat or completely flat. The first major surface 104a faces the food receiving recess 102, and the second major surface 104b defines a circle-shaped recess 108. The lid 103 and the housing 101 may each comprise a metallic material (e.g., tin, steel, aluminum).

The caviar container 100 also includes an electronic device 105 to be received by the circle-shaped recess 108 and comprising a disc-shaped device housing 106, a battery 107 carried within the device housing, a visual indicator 110 carried by the disc-shaped device housing and coupled to the battery, and a processor 111 carried by the disc-shaped device housing and coupled to the battery and the visual indicator. For example, the visual indicator 110 may comprise one or more LEDs carried by an external surface of the disc-shaped device housing 106. The disc-shaped device housing 106 may comprise a dielectric material, such as plastic material, for example, or another rigid material, for example, a metallic material.

The processor 111 is configured to cause the visual indicator to generate a visual indication. The electronic device 105 illustratively includes an overlayer 116 on the visual indicator 110, the overlayer comprising visual indicia 117 (e.g., branding for the product in the food receiving recess 102). The overlayer 116 is at least partially transparent to visual light radiation; therefore, the visual indication is transmitted through the overlayer 116, highlighting the visual indicia 117 to potential customers.

The electronic device 105 illustratively comprises a sensor 112 carried by the disc-shaped device housing 106 and coupled to the processor 111, and the processor 111 is configured to activate the visual indicator 110 based upon the sensor. In some embodiments, the sensor 112 may comprise an ambient light sensor, and the processor 111 may be configured to activate the visual indicator 110 when the ambient light sensor detects an ambient light value below a threshold value, thereby providing a dynamic lighting effect for the customer when the caviar container 100 is in darkened conditions.

Also, in other embodiments, the sensor 112 may comprise a proximity sensor, such as a range finding device. Here, the processor 111 is configured to activate the visual indicator 110 when the proximity sensor detects a moving object within a threshold distance. In some embodiments, the sensor 112 may comprise one or more sensor modalities, such as both of the proximity sensor and the ambient light sensor, thereby activating the visual indicator 110 when the sensor detects the moving object within a threshold distance and when the sensor detects the ambient light value below the threshold value.

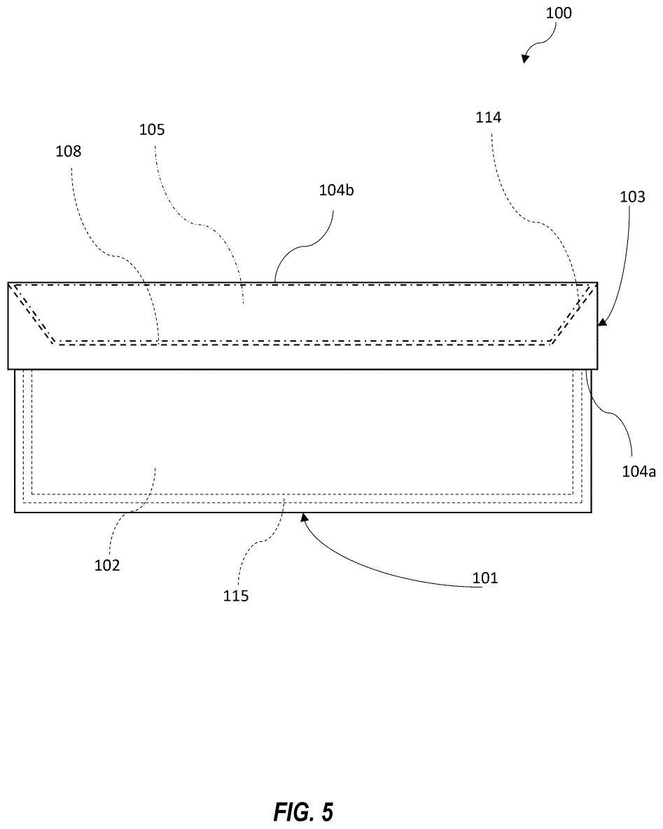

As perhaps best seen in FIG. 5, the circle-shaped recess 108 illustratively defines a canted annular lid wall 120, and the disc-shaped device housing 106 illustratively defines a canted annular device wall 121 to abut the canted annular lid wall. Also, the uppermost portions of the lid 103 are illustratively flush and aligned with uppermost portions of the disc-shaped device housing 106. Helpfully, this provides for a smooth exterior body, which may reduce space for stocking and storing of the caviar container 100. Further, this smooth seamless packaging is desirable in luxury products, such as caviar.

Another aspect is directed to a method for making a caviar container 100. The method comprises forming a housing 101 defining a food receiving recess 102 therein and having a closed first end and an open second end opposite the closed first end, and forming a lid 103 to be received by the open second end of the housing and having opposing first and second major surfaces, the first major surface 104a to face the food receiving recess, the second major surface 104b defining a circle-shaped recess 108. The method also includes positioning an electronic device 105 to be received by the circle-shaped recess 108. The electronic device 105 includes a disc-shaped device housing 106, a battery 107 carried within the device housing, a visual indicator 110 carried by the disc-shaped device housing and coupled to the battery, and a processor 111 carried by the disc-shaped device housing and coupled to the battery and the visual indicator. The processor 111 is configured to cause the visual indicator 110 to generate a visual indication.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. A food container comprising:
a housing defining a food receiving recess therein and having a closed first end and an open second end opposite the closed first end;
a lid to be received by the open second end of the housing and having opposing first and second major surfaces, the first major surface to face the food receiving recess, the second major surface defining a recess; and
an electronic device to be received by the recess and comprising
a device housing,
a battery carried within the device housing,
a visual indicator carried by the device housing and coupled to the battery, and
a processor carried by the device housing and coupled to the battery and the visual indicator, the processor configured to cause the visual indicator to generate a visual indication.

2. The food container of claim 1 wherein the electronic device comprises a sensor carried by the device housing and coupled to the processor; and wherein the processor is configured to activate the visual indicator based upon the sensor.

3. The food container of claim 2 wherein the sensor comprises an ambient light sensor; and wherein the processor is configured to activate the visual indicator when the ambient light sensor detects an ambient light value below a threshold value.

4. The food container of claim 2 wherein the sensor comprises a proximity sensor; and wherein the processor is configured to activate the visual indicator when the proximity sensor detects a moving object within a threshold distance.

5. The food container of claim 1 wherein the recess defines a canted annular lid wall; and wherein the device housing defines a canted annular device wall to abut the canted annular lid wall.

6. The food container of claim 1 wherein the visual indicator comprises at least one light emitting diode (LED) carried by an external surface of the device housing.

7. The food container of claim 1 wherein the electronic device comprises an overlayer on the visual indicator, the overlayer comprising visual indicia.

8. The food container of claim 1 wherein uppermost portions of the lid are flush and aligned with uppermost portions of the device housing.

9. The food container of claim 1 wherein the recess comprises a circle-shaped recess; and wherein the device housing is disc-shaped and received by the circle-shaped recess.

10. The food container of claim 1 wherein the lid and the housing each comprises a metallic material; wherein the device housing comprises a plastic material; and wherein the housing comprises inner surfaces defining the food receiving recess, and a coating layer on the inner surfaces.

11. A caviar container comprising:
a housing comprising inner surfaces defining a food receiving recess therein, a coating layer on the inner surfaces, a closed first end, and an open second end opposite the closed first end, the housing comprising a metallic material;
a lid to be received by the open second end of the housing and having opposing first and second major surfaces, the first major surface to face the food receiving recess, the second major surface defining a circle-shaped recess, the lid comprising a metallic material; and
an electronic device to be received by the circle-shaped recess and comprising
a disc-shaped device housing,
a battery carried within the disc-shaped device housing,
a visual indicator carried by the disc-shaped device housing and coupled to the battery, and
a processor carried by the disc-shaped device housing and coupled to the battery and the visual indicator, the processor configured to cause the visual indicator to generate a visual indication.

12. The caviar container of claim 11 wherein the electronic device comprises a sensor carried by the disc-shaped device housing and coupled to the processor; and wherein the processor is configured to activate the visual indicator based upon the sensor.

13. The caviar container of claim 12 wherein the sensor comprises an ambient light sensor; and wherein the processor is configured to activate the visual indicator when the ambient light sensor detects an ambient light value below a threshold value.

14. The caviar container of claim 12 wherein the sensor comprises a proximity sensor; and wherein the processor is configured to activate the visual indicator when the proximity sensor detects a moving object within a threshold distance.

15. The caviar container of claim 11 wherein the circle-shaped recess defines a canted annular lid wall; and wherein the disc-shaped device housing defines a canted annular device wall to abut the canted annular lid wall.

16. The caviar container of claim 11 wherein the visual indicator comprises at least one light emitting diode (LED) carried by an external surface of the disc-shaped device housing.

17. The caviar container of claim 11 wherein the electronic device comprises an overlayer on the visual indicator, the overlayer comprising visual indicia; and wherein uppermost portions of the lid are flush and aligned with uppermost portions of the disc-shaped device housing.

18. A method for making a food container, the method comprising:
forming a housing defining a food receiving recess therein and having a closed first end and an open second end opposite the closed first end;
forming a lid to be received by the open second end of the housing and having opposing first and second major surfaces, the first major surface to face the food receiving recess, the second major surface defining a recess; and
positioning an electronic device to be received by the recess and comprising
a device housing,
a battery carried within the device housing,
a visual indicator carried by the device housing and coupled to the battery, and
a processor carried by the device housing and coupled to the battery and the visual indicator, the processor configured to cause the visual indicator to generate a visual indication.

19. The method of claim 18 wherein the electronic device comprises a sensor carried by the device housing and coupled to the processor; and wherein the processor is configured to activate the visual indicator based upon the sensor.

20. The method of claim 19 wherein the sensor comprises an ambient light sensor; and wherein the processor is configured to activate the visual indicator when the ambient light sensor detects an ambient light value below a threshold value.
